(19) United States
(12) Patent Application Publication
(10) Pub. No.: US 2026/0348095 A1
(43) Pub. Date: Nov. 5, 2026

(54) MULTIPLY HESPERALOE TISSUE PRODUCTS

(71) Applicant: Kimberly-Clark Worldwide, Inc., Neenah, WI (US)

(72) Inventors: Thomas G. Shannon, Neenah, WI (US); Christoper S. LeCount, Neenah, WI (US); Tatiana A. Kyker, Knoxville, TN (US); Emily E. Schulte, Neenah, WI (US); Jessica J. O'Connor, Appleton, WI (US)

(21) Appl. No.: 19/487,718

(22) PCT Filed: May 31, 2024
(86) PCT No.: PCT/US2024/031825

§ 371 Date: Nov. 25, 2025

Related U.S. Application Data
(60) Provisional application No. 63/469,916, filed on May 31, 2023.

(51) Int. Cl. D21H 11/12; B32B 29/00; D21H 27/00; D21H 27/30

(52) U.S. Cl. CPC D21H 11/12; B32B 29/005; D21H 27/005; D21H 27/30; B32B 2250/02; B32B 2250/26; B32B 2307/54; B32B 2307/5825; B32B 2307/718

(57) ABSTRACT

Multiply tissue products comprising non-wood fibers and more particularly hesperaloe pulp fibers are disclosed. The tissue products preferably comprise at least about 5 percent, by weight of the product, hesperaloe pulp fiber have tensile strengths sufficient to withstand use, particularly scrubbing, such as a geometric mean tensile (GMT) ranging from about 2,000 g/3″ to 5,000 g/3″, yet are relatively soft, such as having a TS7 value less than about 20.0. The soft and strong multiply tissue products have a high degree of durability, even when wet. The soft and strong tissue products are particularly well suited for use as tissue towel and may consist of multiply tissue webs spirally wound about a core.

### BACKGROUND OF THE DISCLOSURE

Tissue products, such as facial tissues, paper towels, bath tissues, napkins, and other similar products, are designed to include several important properties. For example, the products should have good bulk, a soft feel, and should have good strength and durability. Unfortunately, however, when one of these properties is improved another is often adversely affected.ho one or more wood fibers, often referred to as pulp or pulp fibers, which commonly include chemical pulps, such as kraft (sulphate) and sulfite pulps, as well as chemomechanical pulp (CMP) and chemi-thermomechanical pulp (CTMP). Chemical pulps are believed to impart a superior sensation of softness to tissue products made from these pulps. Wood pulps are commonly derived from both deciduous trees (referred to herein as “hardwood”) and coniferous trees (herein referred to as “softwood”), which may be selected and incorporated into the tissue product based upon their physical attributes and the desired physical properties of the resulting tissue product.

To achieve an optimal balance of tissue product properties, the products are often formed from a combination of chemical pulps derived from hardwood and softwood fibers. For example, to optimize surface softness, as is often the case with tissue products, the papermaker will select the fiber furnish based in part on the coarseness of pulp fibers. Pulps having fibers with low coarseness, such as chemical hardwood pulp fibers, are desirable because the tissue product may be softer compared to a comparable product made from fibers having a high coarseness. To optimize surface softness even further, layered structures may be used such that the low coarseness fibers are disposed in the outer layers, where they contact the user, while the inner layer consists of coarser fibers.

Unfortunately, the need for softness is balanced by the need for durability. Durability in tissue products can be defined in terms of tensile strength, tensile energy absorption (TEA), burst strength and tear strength. Typically tear, burst and TEA will show a positive correlation with tensile strength while tensile strength, and thus durability, and softness are inversely related. Thus, the tissue maker is continuously challenged with the need to balance the need for softness with a need for durability. Long papermaking fibers may improve durability, but they may adversely affect softness.

Northem softwood kraft (NSWK) fibers are long fiber of choice for tissue makers because of their ability to provide the best combination of durability and softness, particularly. While NSWK fibers are more coarseness then hardwood pulp fibers, their small cell wall thickness relative to lumen diameter combined with their long length makes them the ideal candidate for optimizing durability and softness in tissue. Unfortunately supply of NSWK is under significant pressure both economically and environmentally. As such, prices of NSWK have escalated significantly creating a need to find alteratives to optimize softness and strength in tissue products. Alternatives, however, are limited. For example, Southern softwood kraft (SSWK) may only be used in limited amounts in the manufacture of tissue products because its high coarseness results in stiffer, harsher feeling products than NSWK.

The pressures placed upon NSWK has led tissue makers to search for alternatives, particularly amongst non-wood fibers. For example, U.S. Pat. No. 5,320,710 discloses the manufacture of tissue using hesperaloe pulp produced by a conventional kraft process. The tissue products, while having certain improved physical properties, were deficient, compared to those produced with NSWK, in terms of bulk, tensile and stiffness. Thus, the tissue products of the '710 patent were generally not suitable for use as premium bath tissue because the strengths and stiffness were excessively high. For example, when compared to Northern® Bathroom Tissue the products of the '710 patent had 300 percent greater tensile strength (measured as GMT) and nearly 250% greater stiffness (measured as GMT divided by Modulus).

Some of these deficiencies of kraft hesperaloe pulp were overcome by pulping hesperaloe using high yield pulping processes. For example, U.S. Pat. No. 10,337,149, disclose tissue products made with high yield hesperaloe pulp, but even then, balancing strength and softness proved difficult. High yield pulping processes where able to moderate the tensile strength of resulting tissue products but tensile still increased relative to products containing NSWK and the increase was not offset by large decrease in stiffness. As a result, substitution of NSWK with high yield hesperaloe pulp often had a negative effect on softness. Thus, there remains a need for an alternative to NSWK for the manufacture of premium tissue products, which must be both soft and strong.

### SUMMARY OF THE DISCLOSURE

The present inventors have successfully used non-wood pulps, particularly pulps produced from hesperaloe, to produce tissue products having softness, strength and bulk comparable or better than that achieved using conventional wood pulp. To produce the instant tissue products the inventors have successfully moderated the changes in strength and stiffness typically associated with substituting conventional wood papermaking fibers, such as NSWK, with non-wood fibers, particularly in the manufacture of multiply tissue products. These changes have generally been achieved by a variety of means, including the use of hesperaloe pulps produced by high yield pulping processes, particularly processes involving mechanical separation of individual fibers and the reduction of fiber length. The resulting tissue products generally have sufficient tensile strength, such as a geometric mean tensile (GMT) of at least about 2,000 g/3″, such as from about 2000 g/3″ to about 5,000 g/3″ and high degree of softness (measured using a Tissue Softness Analyzer as described in the Test Methods below) such as a TS7 value less than about 20.0.

Surprisingly, the improvement in strength and softness may be achieved by distributing the hesperaloe pulp fibers in multiple layers, or through the entire tissue web. Thus, in certain instances, the present invention provides tissue products comprising at least one tissue web or ply comprising a blend of hesperaloe pulp fibers and wood pulp fibers. In this manner the tissue web or ply may be stratified, comprising multiple layers, and the hesperaloe pulp fiber may be disposed in multiple layers or in al of the layers, or it may be unstratified and the hesperaloe pulp fibers may be distributed throughout the web or ply.

Thus, in certain instances the present invention provides a provides tissue products comprising at least one tissue web or ply comprising a blend of hesperaloe pulp fibers and wood pulp fibers, where the fibers are blended such that at least a portion of the hesperaloe pulp fibers are present in the surface of the tissue product brought into contact with a user's skin in-use. Despite having hesperaloe pulp fibers disposed in the outer surface, the inventive tissue products have a high degree of softness, such as a TS7 value equal or less than 0.0018(GMT)+10.304 where GMT is the geometric mean tensile strength of the tissue product having units of grams per three inches. The geometric mean tensile strength of the tissue products is preferably at least about 2,000 g/3″, such as from about 2000 g/3″ to about 5,000 g/3″.

In still other aspects the present invention provides tissue products having relatively moderate amounts of long average fiber length kraft fibers, such as softwood kraft pulp fibers, or are substantially free from long average fiber length kraft fibers. For example, the tissue products may comprise less than about 10 wt %, based upon the total weight of the tissue product, softwood kraft pulp fibers. In other instances, the tissue products of the present invention may be substantially free from softwood kraft pulp fibers, particularly NSWK.

In other aspects the present invention provides a tissue product comprising wood pulp fibers and from about 5 to about 50 weight percent hesperaloe pulp fibers wherein the hesperaloe pulp fibers are blended with wood pulp fibers, the tissue product having a Durability Index of about 40 or greater and a GMT of at least about 2,000 g/3″, such as from about 2000 g/3″ to about 5,000 g/″.

In still other aspects the present invention provides a tissue product comprising wood pulp fibers and from about 5 to about 50 weight percent hesperaloe pulp fibers wherein the hesperaloe pulp fibers are blended with wood pulp fibers, the tissue product having a Durability Index greater of about 40 or greater, a TS7 value less than about 20.0 and a GMT of at least about 2,000 g/3″, such as from about 2000 g/3″ to about 5,000 g/3″.

In yet other instances the present invention provides a method of forming an embossed multiply tissue product comprising the steps of: (a) dispersing hesperloe pulp fiber in water to form a first fiber slurry; (b) dispersing conventional wood pulp fibers in water to form a second fiber slurry; (c) blending the first and the second fiber slurries and depositing them on a moving belt to form a tissue web; (d) non-compressively drying the tissue web to yield a dried tissue web having a consistency from about 80 to about 99 percent solids and comprising at least 5%, by weight of the tissue web, hesperlaoe pulp fibers; (e) embossing a first dried tissue web; and (f) plying the embossed first dried tissue web to a second dried tissue ply to yield an embossed multiply tissue product.

### DESCRIPTION OF THE DRAWINGS

FIG. 1 is a cross-sectional view of a blended tissue web.

FIG. 2 is a cross-sectional view of a layered tissue web.

FIG. 3 is a schematic illustrating an embossing and glue-lamination process useful in the manufacture of multiply tissue products according to the present invention.

FIG. 4 is a graph illustrating the relationship between geometric mean tensile (GMT, having units of g/3″) and TS7 for a tissue product comprising wood pulp fibers (•); and a tissue product comprising EHWK (60 wt %) and high yield hesperaloe pulp fiber (40 wt %) (□).

FIG. 5 is a graph illustrating the relationship between geometric mean tensile (GMT, having units of g/3″) and GM Slope (kg) for a tissue product comprising wood pulp fibers (•); and a tissue product comprising EHWK (60 wt %) and high yield hesperaloe pulp fiber (40 wt %) (□).

FIG. 6 is a graph illustrating the relationship between geometric mean tensile (GMT, having units of g/3″) and GM TEA (g·cm/cm²) for a tissue product comprising wood pulp fibers (•); and a tissue product comprising EHWK (60 wt %) and high yield hesperaloe pulp fiber (40 wt %) (□).

### DEFINITIONS

As used in this application and in the claims, the singular forms “a,” “an,” and “the” include the plural forms unless the context clearly dictates otherwise. Thus, for example, reference to a “yarn” includes aspects having two or more such yarns unless the context clearly indicates otherwise.

It is also to be understood that the terminology used herein is for the purpose of describing particular aspects only and is not intended to be limiting. As used in the specification and in the claims, the term “comprising” can include the aspects “consisting of” and “consisting essentially of.” Additionally, the term “includes” means “comprises.”

For the terms “for example,” “exemplary,” and “such as,” and grammatical equivalences thereof, the phrase “and without imitation” is understood to follow unless explicitly stated otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint and independently of the other endpoint.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein the term “Basesheet” refers to a tissue web formed by any one of the papermaking processes described herein that has not been subjected to further processing, such as embossing, calendering, treatment with a binder or softening composition, perforating, plying, folding, or rolling into individual rolled products.

As used herein the term “Tissue Product” refers to products made from basesheets and includes, bath tissues, facial tissues, paper towels, industrial wipers, foodservice wipers, napkins, medical pads, and other similar products.

As used herein the term “Ply” refers to a discrete tissue web used to form a tissue product. Individual pies may be arranged in juxtaposition to each other.

As used herein, the term “Layer” refers to a plurality of strata of fibers, chemical treatments, or the like, within a ply. The term “Layered Tissue Web” generally refers to a tissue web formed from two or more layers of aqueous papermaking furnish. In certain instances, the aqueous papermaking furnish forming two or more of the layers comprise different fiber types.

As used herein the term “Basis Weight” generally refers to the bone-dry basis weight per unit area of a tissue and is generally expressed as grams per square meter (gsm). Basis weight is measured as described in the Test Methods section below. While the basis weights of tissue products prepared according to the present invention may vary, in certain instances the products may have a basis weight ranging from about 40 to about 100 gsm, including exemplary values of about 40 gsm, about 45 gsm, about 50 gsm, about 55 gsm, about 60 gsm.

As used herein, the term “Caliper” refers to the thickness of a tissue product, web, sheet or ply, typically having units of microns (μm) and is measured as described in the Test Methods section below.

As used herein, the term “Sheet Bulk” refers to the quotient of the caliper (μm) divided by the bone-dry basis weight (gsm). The resulting sheet bulk is expressed in cubic centimeters per gram (cc/g). Tissue products prepared according to the present invention may, in certain instances, have a sheet bulk about 8.0 cc/g or greater, such as about 10.0 cc/g or greater, such as about 12.0 cc/g or greater, such as about 14.0 cc/g or greater, such as from about 8.0 cc/g to about 20 cc/g, such as from about 10.0 cc/g to about 16.0 cc/g.

As used herein, the term “Slope” refers to the slope of the line resulting from plotting tensile versus stretch and is an output of the MTS TestWork™ in the course of determining the tensile strength as described in the Test Methods section herein. Slope is reported in the units of grams (g) per unit of sample width (inches) and is measured as the gradient of the least-squares line fitted to the load-corrected strain points falling between a specimen-generated force of 70 to 157 grams (0.687 to 1.540 N) divided by the specimen width.

As used herein, the term “Geometric Mean Slope” (GM Slope) generally refers to the square root of the product of machine direction slope and cross-machine direction slope. While the GM Slope may vary amongst tissue products prepared according to the present disclosure, in certain instances, may have a GM slope of less than or equal to about 25.0 kg. In other aspects, the GM slope can be from about 10.0 kg to about 25.0 kg or about 12.0 kg to about 24.0 kg, including example values of about 12.0 kg, about 14.0 kg, about 16.0 kg, about 18.0 kg, about 20.0 kg, about 22.0 kg, about 24.0 kg.

As used herein, the term “Geometric Mean Tensile” (GMT) refers to the square root of the product of the machine direction tensile strength and the cross-machine direction tensile strength of the web. The GMT of tissue products prepared according to the present invention may vary, however, in certain instances the GMT may be at least about 2,000 g/3″, such as at least about 2,500 g/3″, such as about least about 3,000 g/3″, such as at least about 3,500 g/3″, such as from about 2,000 to about 5,000 g/3″, such as from about such as from about 2,500 to about 4,500 g/3″, such as from about 3,000 to about 4,000 g/3″.

As used herein, the term “Stiffness Index” refers to the quotient of the geometric mean tensile slope, defined as the square root of the product of the MD and CD slopes (having units of kg), divided by the geometric mean tensile strength (having units of grams per three inches).

$$Stiffness Index = \frac{\sqrt{MD Tensile Slope ( kg ) \times CD Tensile Slope ( kg )}}{GMT ( g / {3}^{″} )} \times 1 , 000$$

While the Stiffness Index of tissue products prepared according to the present disclosure may vary, in certain instances the Stiffness Index may be less than about 7.0, such as less than about 6.0, such as less than about 5.5, such as from about 4.0 to about 7.0, such as from about 4.0 to about 6.0.

As used herein, the term “TEA Index” refers the geometric mean tensile energy absorption (having units of g·cm/cm²) at a given geometric mean tensile strength (having units of grams per three inches) as defined by the equation:

$$TEA Index = \frac{GM TEA ( g cm / {cm}^{2} )}{GMT ( g / {3}^{″} )} \times 1000$$

While the TEA Index may vary, in certain instances tissue products prepared according to the present disclosure have a TEA Index of about 7.0 or greater, such as about 7.5 or greater, such as about 8.0 or greater, such as from about 7.0 to about 10.0.

As used herein, the term “TS7” generally refers to the softness of a tissue product surface measured using an EMTEC Tissue Softness Analyzer (“Emtec TSA”) (Emtec Electronic GmbH, Leipzig, Germany) interfaced with a computer running Emtec TSA software (version 3.19 or equivalent). The units of the TS7 value are dB V² rms, however, TS7 values are often referred to herein without reference to units. Generally, the TS7 value is the magnitude of the peak occurring at a frequency between about 6 and 7 Hz, which is produced by vibration of the tissue membrane during the test procedure. Generally, a lower TS7 value is indicative of a softer tissue product.

As used herein, the term “Fiber Length” refers to the length weighted average length (LWAFL) of fibers determined utilizing an OpTest Fiber Quality Analyzer-360 (OpTest Equipment, Inc., Hawkesbury, ON). The length weighted average length is determined in accordance with the manufacturer's instructions and generally involves first accurately weighing a pulp sample (10-20 mg for hardwood, 25-50 mg for softwood) taken from a one-gram handsheet made from the pulp. The moisture content of the handsheet should be accurately known so that the actual amount of fiber in the sample is known. This weighed sample is then diluted to a known consistency (between about 2 and about 10 mg/l) and a known volume (usually 200 ml) of the diluted pulp is sampled. This 200 ml sample is further diluted to 600 ml and placed in the analyzer. The length-weighted average fiber length is defined as the sum of the product of the number of fibers measured and the length of each fiber squared divided by the sum of the product of the number of fibers measured and the length of the fiber. Fiber lengths are generally reported in millimeters.

As used herein, the term “Coarseness” generally refers to the weight per unit length of fiber, commonly having units of mg/100 meters. Coarseness is measured according to ISO Coarseness Testing Method 23713 utilizing an OpTest Fiber Quality Analyzer-360 (OpTest Equipment, Inc., Hawkesbury, ON).

As used herein, the term “Very Long Fiber Fraction” generally refers to the percentage of fibers having a length (number average fiber length) greater than 6.0 mm and is generally determined using an OpTest Fiber Quality Analyzer-360 (OpTest Equipment, Inc., Hawkesbury, ON) as described in the Test Methods section below. As used herein, the term “Dispersivity Index” generally refers to the ratio of the length weighted average fiber length (L_{w}) to the number average fiber length (Ln). This ratio indicates the fiber length distribution of a given pulp. The length weighted average fiber length (L_{w}) to the number average fiber length (Ln) is generally determined using an OpTest Fiber Quality Analyzer-360 (OpTest Equipment, Inc., Hawkesbury, ON) as described in the Test Methods section below.

As used herein, the term “Hesperaloe pulp fiber” refers to a fiber derived from a plant of the genus Hesperaloe of the family Asparagaoeae including, for example, H. funifera, H. parviflora, H. nocturna, H. chiangii, H. tenuifolia, H. engelmannii, and H. malacophylla. The fibers are generally processed into a pulp for use in the manufacture of tissue products according to the present invention. Preferably the pulping process is a high yield pulping process, such as a pulping process having a yield greater than about 60 percent, such as from about 60 to about 90 percent and more preferably from about 65 to about 95 percent. The foregoing yields generally refer to the yield of unbleached hesperaloe pulp fiber.

As used herein, the term “substantially free” means less than 3 wt %, alternatively less than 2 wt %, alternatively less than 1 wt %, alternatively less than 0.5 wt %, alternatively less than 0.25 wt %, alternatively less than 0.1 wt %, alternatively less than 0.05 wt %, alternatively less than 0.01 wt %, and/or alternatively free of. As used herein, “free of” means 0 wt %.

### DETAILED DESCRIPTION OF THE DISCLOSURE

The present inventors have now discovered that hesperaloe pulp fibers processed by high yield pulping means, such as mechanical pulping, may overcome the limitations of kraft hesperaloe pulp fibers when incorporated into tissue products such as bath tissues, facial tissues, paper towels, industrial wipers, foodservice wipers, napkins, medical pads, and the like. The inventors have discovered that mechanical pulping of hesperaloe yields a pulp having a moderate fiber length, such as a fiber length of about 1.50 mm or greater, such as from about 1.50 to about 2.50 mm, yet a low degree of coarseness, such as less than about 10.0 mg/100 m, such as from about 3.0 to about 10.0 mg/100 m, while producing a moderate degree of tensile strength, such as a pulp Tensile Index of about 55 or less, such as from about 30 to about 55. High yield hesperaloe pulps having the foregoing properties are well suited to replace conventional wood pulps commonly used in the manufacture of tissue products, particularly softwood kraft fibers, without negatively affecting important tissue product properties such as durability, stiffness or softness. In fact, in certain instances many important tissue product properties may be improved by substituting conventional wood pulp fibers with hesperaloe pulp fibers.

Generally, the hesperaloe pulp fibers useful in the present invention have a relatively long fiber length, such as a fiber length of about 1.50 mm or greater, such as about 1.55 mm or greater, such as about 1.60 mm or greater, such as about 1.65 mm or greater, such as about 1.70 mm or greater, such as about 1.75 mm or greater, such as from about 1.50 to about 2.50 mm, such as from about 1.55 to about 2.00 mm. The hesperaloe pulp fibers may also have a fiber coarseness less than about 10.0 mg/100 m, such as less than about 8.0 mg/100 m, such as less than about 6.0 mg/100 m, such as from about 3.0 to about 10.0 mg/100 m, such as from about 3.5 mg/100 m to about 7.0 mg/100 m.

The hesperaloe pulps may also have a relatively modest degree of tensile strength, such as a Tensile Index of about 55 or less, such as about 50 or less, such as about 45 or less, such as about from about 30 to about 55, such as from about 35 to about 50, such as from about 35 to about 45. In other instances, the hesperaloe pulps may have a freeness, where a higher value is indicative of pulps that are more easily dewatered, of about 500 mL or greater, such as about 510 mL or greater, such as about 525 mL or greater, such as about 550 mL or greater, such as from about 500 mL to about 600 mL.

In other instances, the hesperaloe pulps may have a moderate degree of tensile strength and a low degree of fibers having a fiber length greater than 6.0 mm, which can inhibit dispersion of the pulp in water and cause stringing or clumping when the pulp is used to manufacture wet-laid fibrous products. For example, the inventive pulps may have a Tensile Index of about 55 or less, such as about 50 or less and a Very Long Fiber fraction (VLF) of about 1.0% or less, such as about 0.75% or less, such as a about 0.50% or less, such as a VLF from about 0.05% to about 1.0%. a fiber length from about 1.50 to about 2.50. In addition to having reduced tensile strengths and relatively long fiber lengths.

In still other instances the hesperaloe pulps may have a high degree of brightness and/or low content of epidermis debris. Brightness and reduced debris are particularly important for pulps used in the manufacture of tissue products because of the need for a white, bright appearance and a low degree of linting. Accordingly, hesperaloe pulps useful in the present invention may have a Brightness of at least about 75%, more preferably at least about 78% and still more preferably at least about 80%. In other instances, the hesperaloe pulp may have a debris content of about 1.0 wt % or less, such as about 0.90 wt % or less, such as about 0.80 wt % or less, such as about 0.60 wt % or less. In certain instances, it may be desirable to remove substantially all of the debris from the pulp such that the pulp is substantially free from, or free from, debris.

In certain preferred instances, the tissue products of the present invention are produced by a high yield pulping process High yield pulping processes useful for the manufacture of high yield hesperaloe pulps include, for example, mechanical pulp (MP), refiner mechanical pulp (RMP), pressurized refiner mechanical pulp (PRMP), thermomechanical pulp (TMP), high temperature TMP (HT-TMP), RTS-TMP, thermopulp, groundwood pulp (GW), stone groundwood pulp (SGW), pressure groundwood pulp (PGW), super pressure groundwood pulp (PGW-S), thermo groundwood pulp (TGW), thermo stone groundwood pulp (TSGW) or any modifications and combinations thereof. Preferably the high yield pulping process has a yield greater than about 60 percent, such as from about 60 to about 90 percent and more preferably from about 65 to about 90 percent. The foregoing yields generally refer to the yield of unbleached hesperaloe pulp fiber.

In certain instances, high yield hesperaloe pulps may be prepared as described in mechanical pulping process where the hesperaloe biomass or bagasse is treated with an alkaline phosphate prior to or during mechanical refining, such as described in PCT Application No. PCTAJS20211058196, the contents of which are incorporated herein in a manner consistent with the present invention.

In other instances, high yield hesperaloe pulps may be produced using a two-stage mechanical puling process where fibrillation of the hesperaloe biomass or bagasse is carried out in first mechanical pulping stage without the addition of chemicals, such alkaline peroxide chemicals, and/or other chemicals known in the art to bleach or otherwise process lignocellulosic material into pulp or precursors of pulp. Once the hesperaloe biomass or bagasse has been refined to a freeness of about 400 mL or greater, chemicals may be introduced, such as after a first mechanical pulping stage and prior to a second stage of mechanical refining. The foregoing process not only simplifies the pulping process and reduces costs, but it also improves pulp yields and the physical properties of the resulting pulp. For example, the foregoing process may be used to produce hesperaloe pulps at yields of about 80% or greater, such as about 85% or greater, such as about 90% or greater, such as yields from about 80% to about 95%.

In still other instances, high yield hesperaloe pulps may be produced without the addition of chemicals, such alkaline peroxide chemicals, and/or other chemicals known in the art to bleach or otherwise process lignocellulosic material into pulp or precursors of pulp during mechanical refining of the pulp. The hesperaloe pulp may be produced using a process comprising the steps of (a) providing a hesperaloe biomass; (b) cutting the biomass to a nominal length; (c) extracting water soluble solids from the cut biomass to produce a bagasse; (d) mechanically refining the bagasse at a first consistency and at a pH ranging from 6.5 to 7.5 without the addition of chemicals to yield a refined bagasse; (e) mechanically refining the refined bagasse at a pH ranging from 6.5 to 7.5 without the addition of chemicals at a second consistency, wherein the second consistency is less than the first consistency, to yield a high yield hesperaloe pulp useful in the manufacture of tissue products of the present invention.

While in certain instances caustic or an oxidizing agent may be introduced to the process to facilitate fiber separation by the mechanical forces, such addition may not be necessary and in certain instances may be undesirable. For example, in certain instances it be desirable to produce hesperaloe pulp without the addition of caustic to improve yield and moderate the tensile strength of the resulting pulp. Without being bound by any particular theory, it is believed that omitting the addition of caustic during mechanic treatment, particularly mechanical treatment carried out a low consistency, such as consistencies of about 10% or less, particularly from about 3% to about 5%, removes less lignin, improves yield and reduces the tensile strength of the resulting pulp. Thus, the deleterious effect of high tensile strength often associated with the use of hesperaloe pulps in tissue products may be mitigated by omitting chemical treatment during pulping, particularly the use of caustic.

Although, in certain instances, caustic or oxidizing agents may be omitted to reduce the tensile strength of the hesperaloe pulp, they may be employed in some instances, particularly where high degrees of tensile strength are desirable in the finished tissue product. While caustic or oxidizing agents may be added during processing, it is generally preferred that the hesperaloe pulp fiber is not pretreated with a sodium sulfite or the like prior to processing. For example, high yield hesperaloe pulps are generally prepared without pretreatment of the fiber with an aqueous solution of sodium sulfite, or the like, which is commonly employed in the manufacture of chemi-mechanical wood pulps.

In addition to hesperaloe pulp fibers, the tissue products may include one or more papermaking fibers such fibers derived from recycling of wastepaper, cellulosic fibers such as cotton linters, rayon, lyocell and bagasse non-wood pulp fibers and wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred. Pulps derived from both deciduous trees (hereinafter, also referred to as “hardwood”) and coniferous trees (hereinafter, also referred to as “softwood”) may be utilized.

Base tissue webs useful in the formation of tissue products of the present invention may be manufactured using any one of a number of well-known wet-laid papermaking processes such as, for example, creped wet pressed, modified wet pressed, creped through-air dried (CTAD) or uncreped through-air dried (UCTAD). In certain instances, basesheet may be formed using either a wet pressed or a modified wet pressed process such as those disclosed in U.S. Pat. Nos. 3,953,638, 5,324,575 and 6,080,279, the disclosures of which are incorporated herein in a manner consistent with the instant application. In these processes the embryonic tissue web is transferred to a Yankee dryer, which completes the drying process, and then creped from the Yankee surface using a doctor blade or other suitable device.

In other instances, the tissue basesheet may be manufactured by a through-air dried process and be either creped or uncreped. In such processes the embryonic web is noncompressively dried. Suitable through-air dried processes include uncreped through-air dried processes such as those disclosed in U.S. Pat. No. 5,779,860, the contents of which are incorporated herein in a manner consistent with the present disclosure.

In still other instances the tissue basesheet may be manufactured by a process including the step of using pressure, vacuum, or air flow through the wet web (or a combination of these) to conform the wet web into a shaped fabric and subsequently drying the shaped sheet using a Yankee dryer, or series of steam heated dryers, or some other means. Exemplary tissue manufacturing processes include, for example, ATMOS process developed by Voith or the NTT process developed by Metso; or fabric creped tissue, made using a process including the step of transferring the wet web from a carrying surface (belt, fabric, felt, or roll) moving at one speed to a fabric moving at a slower speed (at least 5 percent slower) and subsequently drying the sheet.

In one instance the manufacture of tissue basesheet comprising hesperaloe pulp fibers may be carried out using a twin wire former having a papermaking headbox that injects or deposits an aqueous suspension of papermaking fibers, including hesperaloe pulp fibers, onto a plurality of forming fabrics, such as the outer forming fabric and the inner forming fabric, thereby forming a wet tissue web. The forming process of the present disclosure may be any conventional forming process known in the papermaking industry. Such formation processes include, but are not limited to, Fourdriniers, roof formers such as suction breast roll farmers, and gap formers such as twin wire formers and crescent formers.

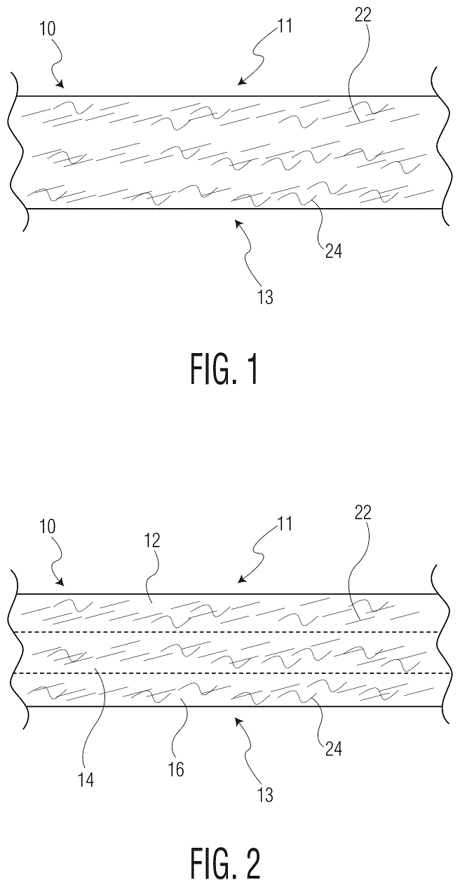

Tissue webs made in accordance with the present disclosure can be made with a homogeneous fiber furnish or can be formed from a stratified fiber furnish producing layers within the multiply tissue product. Homogeneous webs, also referred to herein as blended, may be prepared such that the various fiber furnishes are distributed throughout the web, as illustrated in FIG. 1. As shown in FIG. 1, the web 10 may comprise a first outer surface 11 and second outer surface 13, one or more of the outer surfaces 10, 13 may be brought into contact with the user's skin during use depending upon how the web 10 is converted into a finished product. The web 10 further comprises a blend of hesperaloe pulp fibers 22 and wood pulp fibers 24. The homogenous nature of the fiber furnish is such that the hesperaloe pulp fibers 22 form a portion of the first outer surface 11 and second outer surface 13.

The inventive tissue products may also comprise a stratified web, which may be formed using equipment known in the art, such as a multi-layered headbox. Different fiber furnishes can be used in each layer in order to create a layer with the desired characteristics, however, it may be desirable to distribute the hesperaloe pulp fibers in two or more layers, particularly the layers forming the outer surfaces of the web. For example, as illustrated in FIG. 2 the tissue web 10 may comprises a first outer surface 11 and second outer surface 13 and first and second outer layers, 12, 16 and a middle layer 14. The first outer layer 12 and a second outer layer 16 both contain hesperaloe pulp fibers 22 and wood pulp fibers 24. The middle layer 14 may also contain hesperaloe pulp fibers 22 and wood pulp fibers 24.

When constructing a web from a stratified fiber furnish, the relative weight of each layer may vary. For example, in one instance, when constructing a web containing three layers, each layer can be from about 15 to about 40 percent of the total weight of the web, such as from about 25 to about 35 percent of the weight of the web. Hesperaloe pulp fibers 22 may comprise from about 5 wt % to about 50 wt % of the total weight of the web and may be disposed in the first and second outer layers or may be disposed in the each of the layers in an equal amount.

Although in certain instances the papermaking fibers may be deposited in layers to provide a stratified web, the inventors have now discovered that layer is not necessary to produce tissue products having desirable properties. Accordingly, in certain instances, it may be preferable to deposit hesperaloe pulp fibers throughout the web. In those instances, where a stratified headbox is used to form the web, hesperaloe pulp fibers may be deposited in two or more, or all of, the layers. In other instances, the web may not be stratified and may simply consist of hesperaloe and wood pulp fibers, such as hardwood kraft pulp fibers, blended together. Thus, in certain instances the hesperaloe pulp fibers may be distributed throughout the web, including the outer surface of the web.

The wet tissue web forms on the inner forming fabric as the inner forming fabric revolves about a forming roll. The inner forming fabric serves to support and carry the newly formed wet tissue web downstream in the process as the wet tissue web is partially dewatered to a consistency of about 10 percent based on the dry weight of the fibers. Additional dewatering of the wet tissue web may be carried out by known paper making techniques, such as vacuum suction boxes, while the inner forming fabric supports the wet tissue web. The wet tissue web may be additionally dewatered to a consistency of greater than 20 percent, more specifically between about 20 to about 40 percent, and more specifically about 20 to about 30 percent.

The forming fabric can generally be made from any suitable porous material, such as metal wires or polymeric filaments. For instance, some suitable fabrics can include, but are not limited to, Albany 84M and 94M available from Albany International (Albany, NY) Asten 856, 866, 867, 892, 934, 939, 959, or 937; Asten Synweve Design 274, all of which are available from Asten Forming Fabrics, Inc. (Appleton, WI); and Voith 2164 available from Voith Fabrics (Appleton, WI).

The wet web is then transferred from the forming fabric to a transfer fabric at a consistency of between about 10 to about 35 percent, and particularly, between about 20 to about 30 percent. As used herein, a “transfer fabric” is a fabric that is positioned between the forming section and the drying section of the web manufacturing process.

Transfer to the transfer fabric may be carried out with the assistance of positive and/or negative pressure. For example, in one instance, a vacuum shoe can apply negative pressure such that the forming fabric and the transfer fabric simultaneously converge and diverge at the leading edge of the vacuum slot. Typically, the vacuum shoe supplies pressure at levels between about 10 to about 25 inches of mercury. As stated above, the vacuum transfer shoe (negative pressure) can be supplemented or replaced by the use of positive pressure from the opposite side of the web to blow the web onto the next fabric. In some instances, other vacuum shoes can also be used to assist in drawing the fibrous web onto the surface of the transfer fabric.

Typically, the transfer fabric travels at a slower speed than the forming fabric to enhance the MD and CD stretch of the web, which generally refers to the stretch of a web in its cross-machine (CD) or machine direction (MD) (expressed as percent elongation at sample failure). For example, the relative speed difference between the two fabrics can be from about 1 to about 45 percent, in some instances from about 5 to about 30 percent, and in some instances, from about 15 to about 28 percent. This is commonly referred to as “rush transfer”. During “rush transfer”, many of the bonds of the web are believed to be broken, thereby forcing the sheet to bend and fold into the depressions on the surface of the transfer fabric. Such molding to the contours of the surface of the transfer fabric may increase the MD and CD stretch of the web.

The wet tissue web is then transferred from the transfer fabric to a through-air drying fabric. Typically, the transfer fabric travels at approximately the same speed as the through-air drying fabric. However, a second rush transfer may be performed as the web is transferred from the transfer fabric to the through-air drying fabric. This rush transfer is referred to as occurring at the second position and is achieved by operating the through-air drying fabric at a slower speed than the transfer fabric.

While supported by a through-air drying fabric, the wet tissue web is dried to a final consistency of about 94 percent or greater by a through-air dryer. The web then passes through the winding np between the reel drum and the reel and is wound into a roll of tissue for subsequent converting.

In other instances, the embryonic fibrous structure is formed by a wet-laid forming section and transferred to a through-air drying fabric with the aid of vacuum air. The embryonic fibrous structure is molded to the through-air drying fabric and partially dried to a consistency of about 40 to about 70 percent with a through-air dried process. The partially dried web is then transferred to the surface of a cylindrical dryer, such as a Yankee dryer, by a pressure roll. The web is pressed and adhered onto the Yankee dryer surface having a coating of creping adhesive. The fibrous structure is dried on the Yankee surface to a moisture level of about 1 to about 5 percent moisture where it is separated from the Yankee surface with a creping process. The creping blade bevel can be from 15 to about 45 percent with the final impact angle from about 70 to about 105 degrees.

In certain instances, a layer or other portion of the web, including the entire web, can be provided with wet or dry strength agents. As used herein, “wet strength agents” are materials used to immobilize the bonds between fibers in the wet state. Any material that when added to a paper web or sheet at an effective level results in providing the sheet with a wet geometric tensile strength:dry geometric tensile strength ratio in excess of 0.1 will, for purposes of this invention, be termed a wet strength agent. Typically, these materials are termed either as permanent wet strength agents or as “temporary” wet strength agents. For the purposes of differentiating permanent from temporary wet strength, permanent will be defined as those resins which, when incorporated into paper or tissue products, will provide a product that retains more than 50 percent of its original wet tensile strength after exposure to water for a period of at least five minutes. permanent wet strength agents are those which show less than 50 percent of their original wet strength after being saturated with water for five minutes. Both classes of material find application in the present invention. The amount of wet strength agent or dry strength added to the pulp fibers can be at least about 0.1 dry weight percent, more specifically about 0.2 dry weight percent or greater, and still more specifically from about 0.1 to about 3 dry weight percent, based on the dry weight of the fibers.

Useful dry strength additives include carboxymethyl cellulose resins, starch-based resins, and mixtures thereof. Examples of preferred dry strength additives include naturally derived starches, carboxymethyl cellulose and cationic modified starches such as those commercially available under the tradename REDIBOND™ (Ingredion inc., Westchester, IL, U.S.A.).

Suitable temporary wet strength resins include, but are not limited to, polyacrylamide resins, particularly glyoxyalated polyacrylamide resins and still more particularly cationic glyoxyalated polyacrylamide resins. Suitable temporary wet strength resins are described in U.S. Pat. Nos. 3,556,932 and 3,556,933. Useful temporary wet strength agents include those commercially available under the tradename FennoBond™ (Solenis LLC, Wilmington, DE, U.S.A) and AxStrength™ (Axchem Group, Wilmington, DE, U.S.A)

In certain instances, particularly in the manufacture of bath tissue and other tissue products that may be disposed of in a wastewater system, it may be preferable to omit permanent wet strength agents. Common permanent wet strength agents include polyamide-epichlorohydrn resins, polyacrylamide resins, and mixtures thereof. Although it may be desirable, in certain instances, to omit permanent wet strength agents the products of the present invention may comprise a temporary wet strength agent.

Although wet and dry strength agents as described above find particular advantage for use in connection with this invention, other types of bonding agents can also be used to provide the necessary wet resiliency. They can be applied at the wet end of the basesheet manufacturing process or applied by spraying or printing after the basesheet is formed or after it is dried.

In other instances, the web or one or more layers of a stratified web, such as the middle layer of a three-layered web, may be formed without a substantial amount of inner fiber-to-fiber bond strength. In this regard, the fiber furnish may be treated with a chemical debonding agent. The debonding agent can be added to the fiber slurry during the pulping process or can be added directly into the headbox. Suitable debonding agents that may be used in the present invention include cationic debonding agents, particularly quaternary ammonium compounds, mixtures of quaternary ammonium compounds with polyhydroxy compounds, and modified polysiloxanes.

Suitable cationic debonding agents include, for example, fatty dialkyl quintenary amine salts, mono fatty alkyl tertiary amine salts, primary amine salts, imidazoline quintenary salts, silicone quaternary salt and unsaturated fatty alkyl amine salts. Other suitable debonding agents are disclosed in U.S. Pat. No. 5,529,665, the contents of which are incorporated herein in a manner consistent with the present disclosure. Particularly preferred debonders may comprise an organic quaternary ammonium chloride and particularly a silicone-based amine salt of a quaternary ammonium chloride. Useful debonders are commercially available under the tradename ProSoft™ (commercially available from Solenis, Wilmington, DE, U.S.A.). The debonding agent can be added to the fiber slurry in an amount of from about 1.0 kg per metric tome to about 15 kg per metric tonne of fibers present within the slurry.

Particularly useful quatemary ammonium debonders include imidazoline quatemary ammonium debonders, such as oleyl-imidazoline quaternaries, dialkyl dimethyl quatemary debonders, ester quaternary debonders, diamidoamine quatemary debonders, and the like. The imidazoline-based debonding agent can be added in an amount of between 1.0 to about 10 kg per metric tonne.

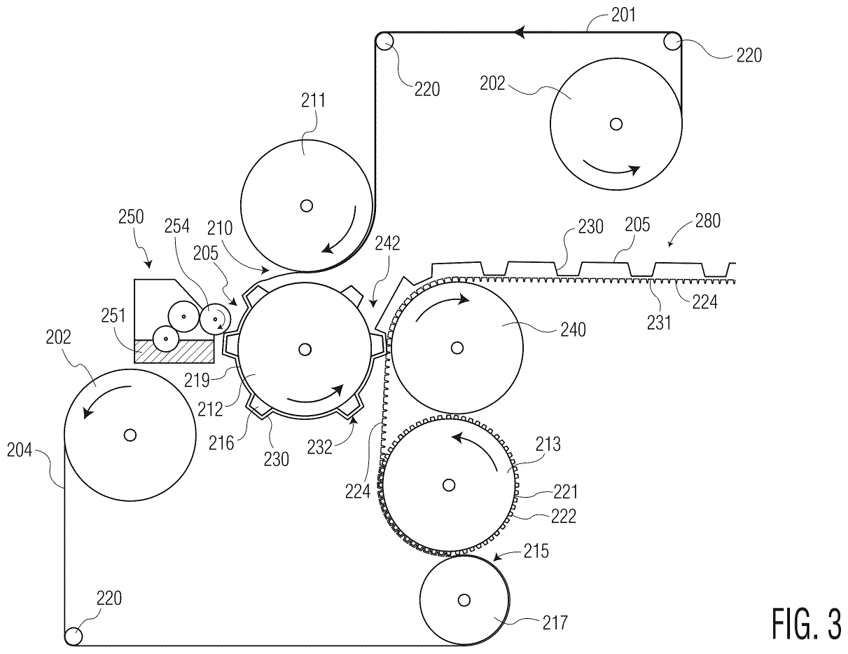

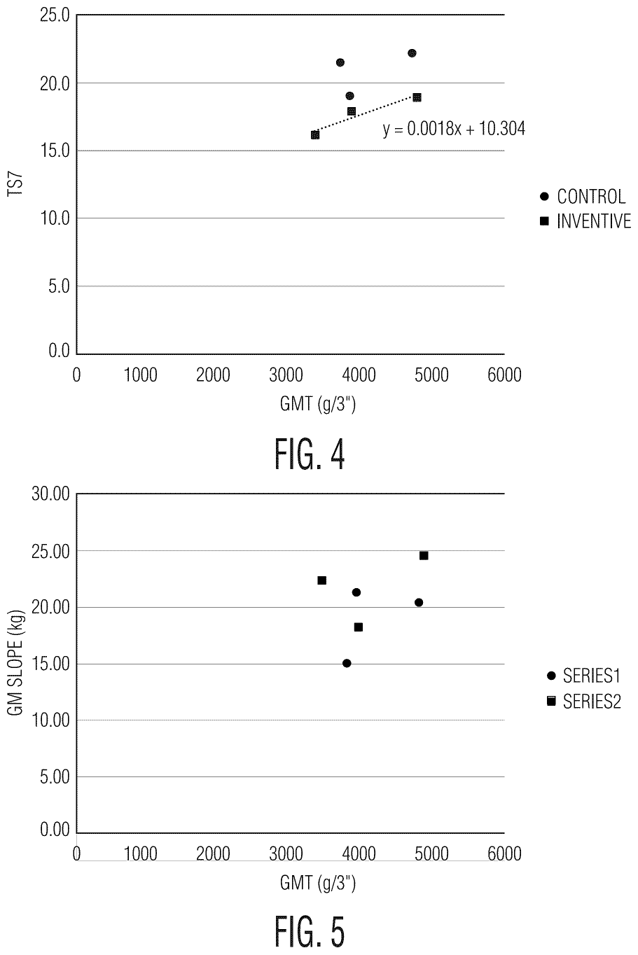

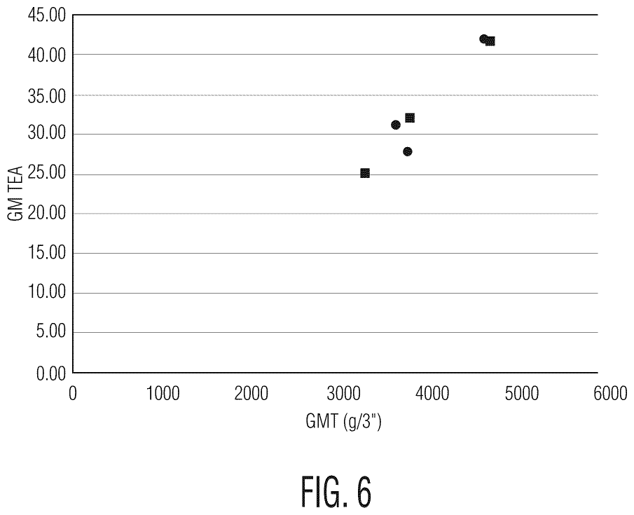

Tissue webs, prepared as described above, may be converted into multiply tissue products using any number of well-known plying processes. One exemplary process for plying and embossing tissue plies is illustrated in FIG. 3. In the illustrated process, a first tissue ply 201, which will form the uppermost ply of the finished tissue product, is unwound from a first parent roll 202 and conveyed past a series of idler rollers 220 towards a first embossing nip 210 located between a first engraved embossing roll 212 and a first impression roll 211. The engraved embossing roll 212 rotates in the counterclockwise direction while the impression roll 211 rotates in the clockwise direction.

The engraved embossing roll 212 is generally a hard and non-deformable roll, such as a steel roll, and comprises a plurality of protuberances 216, also referred to herein as embossing elements, extending radially from a first peripheral surface 219. The protuberances are arranged so as to form at least a first embossing pattern. The protuberances have a radial height generally measured from the first peripheral surface of the roll, which is understood to be the circumferential surface of the roll having the least radial height when measured from the axis of the roll, or some other common reference point. In certain embodiments the radial height of the protuberances may be about 1.30 mm or greater, such as from about 1.30 to about 1.50 mm and more preferably from about 1.35 to about 1.45 mm.

With continue reference to FIG. 3, the first engraved embossing roll 212 is urged against the first impression roll 211, which preferably has a substantially smooth deformable outer surface. In certain instances, the impression roll may be a roll with a covering made of natural or synthetic rubber, for example, polybutadiene or copolymers of ethylene and propylene, or the like. For example, the outer surface of the impression roll may be a synthetic rubber having a hardness greater than about 40 Shore (A), such as from about 40 to about 100 Shore (A) and more preferably from about 40 to about 80 Shore (A).

The first impression roll 211 and the first engraved embossing roll 212 are urged together to form a first embossing nip 210 through which the first tissue ply 201 passes to impose a first embossing pattern thereon. Generally, a force or pressure is applied to one or both of the rolls such that the rolls are urged against one another causing the impression roll to deform about the protuberances such that when the ply is pressed about the protuberances and onto the landing areas (i.e., the outer surface areas of the roll surrounding the protuberances) an embossment results. As the embossed first tissue ply 205 exits the first embossing nip 210 it comprises a plurality of embossments 230 having distal ends 232.

To form a two-ply tissue product, a second parent roll 202 is unwound and the second tissue ply 204 is conveyed around an idler roller 220 and is then passed into a second embossing nip 215 formed between a second impression roll 217 and a second engraved embossing roll 213. The second impression roll generally has a smooth outer surface, which may be deformable. In certain instances, the second impression roll has an outer covering comprising a natural or synthetic rubber and may have a hardness greater than about 40 Shore (A), such as from about 40 to about 100 Shore (A). The second engraved embossing roll 213 generally comprises a plurality of protuberances 222 extending from its peripheral surface 221. The protuberances are generally in the form of dot elements and form a second embossing pattern. In certain embodiments the protuberances disposed on the second engraved embossing roll may have a height of at least about 0.4 mm, such as from about 0.4 to about 2.0 mm.

As the second ply 204 passes through the second embossing nip 215 it is imparted with a plurality of dot emboss elements 231, which may be arranged to form a pattern. The embossed second ply 224 is then conveyed and brought into facing relation with the embossed first ply 205 using a marrying roll 240, as will be described in more detail below. While in certain instances the second engraved embossing roll 213 and impression roll 217 may be arranged relatively close to the first pair of rolls 211, 212 and the marrying roll 240, this is not necessary as the present method does not relying upon registration of the first and second embossing patterns with one another. In this manner, the present method differs from so called nested-method embossing, such as that described in U.S. Publ No. 20120156447. where the embossing elements of the first embossing roll and the embossing elements of the second embossing roll are arranged such that the embossed elements of the first embossed ply and the embossed elements of the second embossed ply fit into each other similar to a gearing system.

After the embossed second ply 224 leaves the second embossing nip 215 it is brought into facing relationship with the embossed first ply 205. The two embossed plies 205, 224 are conveyed through a third nip 242 formed between the first engraved embossing roll 212 and a marrying roll 240, which may be a steel roll having a substantially smooth outer surface. The first and second embossed plies 205, 224 are joined together as they pass through the third nip 242 to form a multiply tissue product 280.

In certain instances, the plies may be adhesively attached to one another by applying an adhesive to one of the plies as itis engaged with an patterned embossing roll. For example, as shown in FIG. 3, after exiting the first embossing nip 210 the first embossed ply 205 encounters a gluing unit 250, which comprises an adhesive 251 disposed in a reservoir and an applicator roll 252. Adhesive 251 is transferred to the applicator roll 252 and applied to the distal ends 232 of the embossments 230 that are formed on the exterior surface of the embossed first tissue ply 205 by virtue of contact with the first protuberances 216. The embossed first tissue ply 205 with the applied adhesive 251 then advances further to the third nip 242 between the first engraved embossing roll 212 and the marrying roll 240. At this point, the embossed second ply 224 is attached to the embossed first ply 205 and then conveyed through the third nip 242 to form an adhesively laminated two-ply tissue product 280 which is subsequently wound into a roll (not shown).

The resulting two-ply tissue product 280 comprises embossed first and second plies 205, 224 with the first embossed ply 205 forming the upper most surface of the tissue product 280 and the second ply 224 forming the bottom most surface

The instant multiply tissue product may be constructed from two or more plies that are manufactured using the same or different tissue making techniques. For example, the inventive tissue products may comprise two thorough-air dried tissue plies where each ply has a basis weight greater than about 20 gsm, such as from about 20 to about 50 gsm, such as from about 22 to about 30 gsm, where the plies have been attached to one another by a glue laminating embossing process which provides the tissue product with an embossing pattern on at least one of its outer surfaces.

Regardless of how the basesheet is converted to tissue products, the products of the present invention generally comprise at least about 5 percent, such as at least about 10 percent, such as at least about 15 percent, such as at least about 20 percent, such as at least about 25 percent, such as at least about 30 percent, such as from about 5 to about 50 percent, such as from about 7.5 to about 45 percent, such as from about 10 to about 40 percent hesperaloe pulp fiber.

Hesperaloe pulp fiber may replace al or a portion of the long wood pulp fiber fraction of the papermaking furnish, such as NSWK or SSWK. Accordingly, in certain instances, the tissue products may comprise less than about 25 wt % NSWK or SSWK, such as less than about 15 wt % NSWK or SSWK, such as less than about 15 wt % NSWK or SSWK. In certain instances, hesperaloe pulp fiber may replace all of the long wood pulp fibers of the papermaking furnish such that the tissue product is substantially free from, and in certain instances free from, long wood pulp fibers such as NSWK or SSWK.

In certain instances, the inventive tissue products may have a GMT greater than about 700 g/3″, such as greater than about 750 g/3″, such as greater than about 800 g/3″, such as greater than about 850 g/3″, such as greater than about 900 g/3″, such as greater than about 1,000 g/3″, such as greater than about 1,050 g/3″, such as from about 700 to about 1,500 g/3″, such as from about such as from about 800 to about 1,250 g/3″, such as from about 850 to about 1,200 g/3″.

The tissue products of the present invention may have a basis weight of from about 40 to about 100 gsm, including exemplary values of about 40 gsm, about 45 gsm, about 50 gsm, about 55 gsm, about 60 gsm. In certain instances, the tissue products may comprise a multiply product, such as a two- or three-ply tissue product, and may have a basis weight from about 40 gsm to about 60 gsm.

The tissue products of the present invention may have a sheet bulk of about 8.0 cc/g or greater, such as about 10.0 cc/g or greater, such as about 12.0 cc/g or greater, such as about 14.0 cc/g or greater, such as from about 8.0 cc/g to about 20 cc/g, such as from about 10.0 cc/g to about 16.0 cc/g.

The tissue products of the present invention are generally soft and have a moderate degree of strength. As such, the tissue products may have a TS7 value of about 20.0 or less, such as about 18.0 or less, such as about 16.0 or less, as from about 12.0 to about 20.0, such as from about 14.0 to about 18.0 The foregoing levels of softness may be achieved at tensile strengths (measured as GMT) of at least about 2,000 g/3″, such as at least about 2,500 g/3″, such as about least about 3,000 g/3″, such as at least about 3,500 g/3″, such as from about 2,000 to about 5,000 g/3″, such as from about such as from about 2,500 to about 4,500 g/3″, such as from about 3,000 to about 4,000 g/3″.

In other instances, the tissue products of the present invention may have a TS7 value equal or less than 0.0018(GMT)+10.304 where GMT is the geometric mean tensile strength of the tissue product having units of grams per three inches. The geometric mean tensile strength of the tissue products is preferably at least about 2,000 g/3″, such as from about 2000 g/3″ to about 5,000 g/3″.

Although the tissue products of the present invention are soft and have a modest degree of tensile strength, the products have a surprisingly high degree of durability. For example, the tissue products may have a Durability Index of about 40 or greater, such as about 42 or greater, such as about 44 or greater, such as from about 40 to about 50. The foregoing Durability Index levels may be achieved despite the products having a GMT of at least about 2,000 g/3″, such as from about 2000 g/3″ to about 5,000 g/3″.

The tissue products may have a geometric mean tear strength (GM Tear) of about 30.0 gf or greater, such as about 32.0 gf or greater, such as about 34.0 gf or greater, such as about 36.0 gf or greater, such as from about 30.0 gf to about 40.0 gf. In certain instances, the tissue products may have a relatively high degree of tear strength and a moderate degree of tensile strength such that the Tear Index is about 9.0 or greater, such as about 9.5 or greater, such as about 10.0 or greater, such as about 10.5 or greater, such as from about 9.0 to about 12.0.

The tissue products may have a Dry Burst strength of about 700 gf or greater, such as about 750 gf or greater, such as about 800 gf or greater, such as about 850 gf or greater, such as about 900 gf or greater, such as about 950 gf or greater, such as from about 800 to about 1,200 gf, such as from about 900 to about 1,000 gf. In certain instances, the tissue products may have a relatively high degree of dry burst strength and a moderate degree of tensile strength such that the Burst Index is about 7.0 or greater, such as about 7.5 or greater, such as about 8.0.

The tissue products may have a geometric mean tensile energy absorption (GM TEA) of about 25.0 g·cm/cm² or greater, such as about 28.0 g·cm/cm² or greater, such as about 30.0 g·cm/cm² or greater, such as about 32.0 g·cm/cm² or greater, such as about 34.0 g·cm/cm² or greater, such as from about 25.0 to about 50.0 g·cm/cm². In certain instances, the tissue products may have a relatively high degree of tear strength and a moderate degree of tensile strength such that the TEA Index is about 7.0 or greater, such as about 7.5 or greater, such as about 8.0 or greater, such as from about 7.0 to about 10.0.

In other instances, the tissue products have a Stiffness Index of about 10.0 or less, such as less than about 9.0, such as less than about 8.0, such as less than about 7.0, such as less than about 6.0, such as less than about 5.5, such as from about 4.0 to about 10.0, such as from about 4.0 to about 8.0. The tissue products may have a low degree of stiffness, such as a Stiffness Index from about 4.0 to about 8.0, and a relatively high degree of durability, such as a Durability Index of about from about 40 to about 50.

### Test Methods

### Fiber Properties

Fiber properties such as length, coarseness, percentage of fines, and fraction of very long fiber, are generally determined using an OpTest Fiber Quality Analyzer-360 (OpTest Equipment, Inc., Hawkesbury, ON) in accordance with the manufacturer's instructions. Samples are generally prepared by first accurately weighing a pulp sample. The sample mass may range from about 10 to about 50 mg (bone dry) and may be taken from a handsheet or pulp sheet. The weighed sample is diluted to a known consistency (between about 2 and about 10 mg/l). An aliquot of the diluted sample (usually 200 ml) is further diluted to a final volume of 600 ml and placed in the analyzer. The sample is then analyzed according to the manufacturer's instructions and the output of the analyzer, such as the length weighted average fiber length, coarseness, length weighted fines, and a histogram illustrating the distribution of various fiber properties for a given sample are recorded. Generally, each reported fiber property is the average of three replicates.

The output of the fiber quality analyzer is used to calculate the Very Long Fiber (VFL) fraction, which is the sum of fiber count from 6 to 14.95 mm divided by the total fiber count Generally, the bin data output by the instrument, which provides the number of individual fibers counted within a given fiber length range, is used to determine VLF. The total number of individual fibers counted (N) and the total number of individual fibers counted having a length of 6 mm or greater (n) are determined from the bin data. The % VLF=n/N100.

The output of the fiber quality analyzer is also used to calculate the ratio of the length weighted average fiber length (L_{w}) to the number average fiber length (Lₙ). L_{w} and Lₙ are calculated by the FQA software using the following equations:

$${L}_{w} = \frac{{\sum }_{All Fibers} {n}_{i} {L}_{i}^{2}}{{\sum }_{All Fibers} {n}_{i} {L}_{i}} {L}_{n} = \frac{{\sum }_{All Fibers} {n}_{i} {L}_{i}}{{\sum }_{All Fibers} {n}_{i}}$$

Where n and L are determined by the instrument in the course of analyzing a sample. The ratio of the length weighted average fiber length (L_{w}) to the number average fiber length (Lₙ) indicates the fiber length distribution of the sample. A higher ratio is indicative of a broader fiber length distribution. A value of 1 indicates that all of the fibers in the sample have the same length.

Fiber coarseness is measured using the FQA instrument and is measured “as-is” without removal of fines. Consistency of the pulp sample is determined using TAPPI methods T-240 or the equivalent and the consistency (%) is recorded to the nearest 0.01%. Based upon the measured consistency, the amount of undried sample required to yield approximately 0.015 grams of oven dried pulp is calculated and weighed out and the weight recorded to the nearest 0.0001 g. The weighed undried pulp is transferred to a British pulp disintegrator or equivalent pulp disintegrator and the total volume of the sample is diluted to 2 liters with deionized water and disintegrated 15,000 revolutions according to the manufacturer's instructions. The disintegrated sample is further diluted with deionized water to a total volume of 5 liters±50 mL and the volume is recorded to the nearest 10 mL. The diluted sample is agitated by stirring and approximately 600 grams are weighted out into a clean beaker. The mass of the sample weighed out to the beaker is recorded to the nearest 0.1 g. The oven dried weight of the pulp sample to be analyzed is then calculated as shown in the equation below and fiber analysis is carried out according to the manufacturers instructions.

$$O . D . Mass of Pulp ( g ) = \frac{\begin{matrix}Undried Pulp ( g ) \times Consistency of undried sample ( \% ) \times \\ Mass of Sample ( g )\end{matrix}}{Diluted Sample Volume ( mL ) \times 10}$$

### Basis Weight

Basis weight of sample is measured by selecting twelve (12) products (also referred to as sheets) of the sample and making two (2) stacks of six (6) sheets. In the event the sample consists of perforated sheets of bath or towel tissue, the perforations must be aligned on the same side when stacking the usable units. A precision cutter is used to cut each stack into exactly 10.16×10.16 cm (4.0×4.0 inch) squares. The two stacks of cut squares are combined to make a basis weight pad of twelve (12) squares thick.

The basis weight pad is then placed in the uncovered container and the container with sample is placed in a 105±2 °C oven for an hour. After an hour, the lid is placed on the container and the container is removed from the oven and allowed to cool to approximately room temperature.

The covered container with sample is then weighed on a top loading balance with a minimum resolution of 0.01 grams. The top loading balance must be protected from air drafts and other disturbances using a draft shield. Weights are recorded when the readings on the top loading balance become constant. The weight of the container and lid are subtracted to determine the sample weight in grams. The mass of the sample (grams) per unit area (square meters) is calculated and reported as the basis weight, having units of grams per square meter (gsm).

### Caliper

Caliper is measured in accordance with TAPPI test methods Test Method T 580 pm-12 “Thickness (caliper) of towel, tissue, napkin and facial products.” The micrometer used for carrying out caliper measurements is an Emveco 200-A Tissue Caliper Tester (Emveco, Inc., Newberg, OR). The micrometer has a load of 2 kilo-Pascals, a pressure foot area of 2,500 square millimeters, a pressure foot diameter of 56.42 millimeters, a dwell time of 3 seconds and a lowering rate of 0.8 millimeters per second.

### Burst Strength (Wet or Dry)

Burst Strength is measured using an EJA Burst Tester (series #50360, commercially available from Thwing-Albert Instrument Company, Philadelphia, PA). The test procedure is according to TAPPI T570 pm-00 except the test speed. The test specimen is clamped between two concentric rings whose inner diameter defines the circular area under test. A penetration assembly, the top of which is a smooth, spherical steel ball, is arranged perpendicular to and centered under the rings holding the test specimen. The penetration assembly is raised at 6 inches per minute such that the steel ball contacts and eventually penetrates the test specimen to the point of specimen rupture. The maximum force applied by the penetration assembly at the instant of specimen rupture is reported as the burst strength in grams force (gf) of the specimen.

The penetration assembly consists of a spherical penetration member which is a stainless-steel ball with a diameter of 0.625±0.002 inches (15.88±0.05 mm) finished spherical to 0.00004 inches (0.001 mm). The spherical penetration member is permanently affixed to the end of a 0.375±0.010 inch (9.525±0.254 mm) solid steel rod. A 2000 gram load cell is used and 50 percent of the load range i.e., 0-1000 g is selected. The distance of travel of the probe is such that the upper most surface of the spherical ball reaches a distance of 1.375 inches (34.9 mm) above the plane of the sample clamped in the test. A means to secure the test specimen for testing consisting of upper and lower concentric rings of approximately 0.25 inches (6.4 mm) thick aluminum between which the sample is firmly held by pneumatic damps operated under a filtered air source at 60 psi. The damping rings are 3.50±0.01 inches (88.9±0.3 mm) in internal diameter and approximately 6.5 inches (165 mm) in outside diameter. The damping surfaces of the damping rings are coated with a commercial grade of neoprene approximately 0.0625 inches (1.6 mm) thick having a Shore hardness of 70-85 (A scale). The neoprene needs not cover the entire surface of the damping ring but is coincident with the inner diameter, thus having an inner diameter of 3.50±0.01 inches (88.9±0.3 mm) and is 0.5 inches (12.7 mm) wide, thus having an external diameter of 4.5±0.01 inches (114±0.3 mm). For each test a total of 3 sheets of product are combined.

The sheets are stacked on top of one another in a manner such that the machine direction of the sheets is aligned. Where samples comprise multiple plies, the plies are not separated for testing. In each instance the test sample comprises 3 sheets of product. For example, if the product is a 2-ply tissue product, 3 sheets of product, totaling 6 plies are tested. If the product is a single ply tissue product, then 3 sheets of product totaling 3 plies are tested.

Samples are conditioned under TAPPI conditions for a minimum of four hours and cut into 127×127±5 mm squares. For wet burst measurement, after conditioning the samples were wetted for testing with 0.5 mL of deionized water dispensed with an automated pipette. The wet sample is tested immediately after insulting.

The peak load (gf) and energy to peak (g-cm) are recorded and the process repeated for all remaining specimens. A minimum of five specimens are tested per sample and the peak load average of five tests is reported.

### Tear

Tear testing was carried out in accordance with TAPPI test method T-414 “Internal Tearing Resistance of Paper (Elmendorf-type method)” using a falling pendulum instrument such as Lorentzen & Wettre Model SE 009. Tear strength is directional, and MD and CD tear are measured independently.

More particularly, a rectangular test specimen of the sample to be tested is cut out of the tissue product or tissue base sheet such that the test specimen measures 63±0.15 mm (2.5±0.006 inches) in the direction to be tested (such as the MD or CD direction) and between 73 and 114 mm (2.9 and 4.6 inches) in the other direction. The specimen edges must be cut parallel and perpendicular to the testing direction (not skewed). Any suitable cutting device, capable of the prescribed precision and accuracy, can be used. The test specimen should be taken from areas of the sample that are free of folds, wrinkles, crimp lines, perforations or any other distortions that would make the test specimen abnormal from the rest of the material.

The number of plies or sheets to test is determined based on the number of plies or sheets required for the test results to fall between 20 to 80 percent on the linear range scale of the tear tester and more preferably between 20 to 60 percent of the linear range scale of the tear tester. The sample preferably should be cut no closer than 6 mm (0.25 inch) from the edge of the material from which the specimens will be cut. When testing requires more than one sheet or ply the sheets are placed facing in the same direction.

The test specimen is then placed between the clamps of the falling pendulum apparatus with the edge of the specimen aligned with the front edge of the damp. The damps are closed, and a 20-millimeter slit is cut into the leading edge of the specimen usually by a cutting knife attached to the instrument. For example, on the Lorentzen & Wettre Model SE 009 the slit is created by pushing down on the cutting knife lever until it reaches its stop. The slit should be dean with no tears or nicks as this slit will serve to start the tear during the subsequent test.

The pendulum is released and the tear value, which is the force required to completely tear the test specimen, is recorded. The test is repeated a total of ten times for each sample and the average of the ten readings reported as the tear strength. Tear strength is reported in units of grams of force (gf). The average tear value is the tear strength for the direction (MD or CD) tested. The “geometric mean tear strength” is the square root of the product of the average MD tear strength and the average CD tear strength. The Lorentzen & Wettre Model SE 009 has a setting for the number of plies tested. Some testers may need to have the reported tear strength multiplied by a factor to give a per ply tear strength. For base sheets intended to be multiple ply products, the tear results are reported as the tear of the multiple ply product and not the single ply base sheet. This is done by multiplying the single ply base sheet tear value by the number of plies in the finished product. Similarly, the tear strength of products comprising multiple plies is reported as the tear strength for the finished product sheet and not the individual plies. A variety of means can be used to calculate but in general will be done by inputting the number of sheets to be tested rather than the number of plies to be tested into the measuring device. For example, two sheets would be two 1-ply sheets for 1-ply product and two 2-ply sheets (4-plies) for 2-ply products.

### Tensile

Tensile testing is conducted on a tensile testing machine maintaining a constant rate of elongation and the width of each specimen tested is 3 inches. Testing is conducted under TAPPI conditions. Prior to testing samples are conditioned under TAPPI conditions (23±1 °C and 50±2 percent relative humidity) for at least 4 hours and then cutting a 3±0.05 inches (76.2±1.3 mm) wide strip in either the machine direction (MD) or cross-machine direction (CD) orientation using a JDC Precision Sample Cutter (Thwing-Albert Instrument Company, Philadelphia, PA, Model No. JDC 3-10, Serial No. 37333) or equivalent. The instrument used for measuring tensile strengths was an MTS Systems Sintech 11S, Serial No. 6233. The data acquisition software was MTS TestWorks® for Windows Ver. 3.10 (MTS Systems Corp., Research Triangle Park, NC). The load cell was selected from either a 50 Newton or 100 Newton maximum, depending on the strength of the sample being tested, such that the majority of peak load values fall between 10 to 90 percent of the load cell's full-scale value. The gauge length between jaws was 4±0.04 inches (101.6±1 mm) for facial tissue and towels and 2±0.02 inches (50.8±0.5 mm) for bath tissue. The crosshead speed was 10±0.4 inches/min (254±1 mm/min), and the break sensitivity was set at 65 percent. The sample was placed in the jaws of the instrument, centered both vertically and horizontally. The test was then started and ended when the specimen broke. The peak load was recorded as either the “MD tensile strength” or the “CD tensile strength” of the specimen depending on direction of the sample being tested. Ten representative specimens were tested for each product or sheet and the arithmetic average of all individual specimen tests was recorded as the appropriate MD or CD tensile strength having units of grams per three inches (g/3″). Tensile energy absorbed (TEA) and slope are also calculated by the tensile tester. TEA is reported in units of g·cm/cm² and slope is recorded in units of kilograms (kg). Both TEA and Slope are directionally dependent and thus MD and CD directions are measured independently.

All products were tested in their product forms without separating into individual plies. For example, a 2-ply product was tested as two plies and recorded as such. In the tensile properties of basesheets were measured, the number of plies used varied depending on the intended end use. For example, if the basesheet was intended to be used for 2-ply product, two plies of basesheet were combined and tested.

### Softness

Softness was measured using an EMTEC Tissue Softness Analyzer (“TSA”) (Emtec Electronic GmbH, Leipzig, Germany), calibrated according to the manufacturer's instructions. The TSA comprises a rotor with vertical blades which rotate on the tissue sample applying a defined contact pressure. The blades are pressed against the sample with a load of 100 mN and the rotational speed of the blades is two revolutions per second. Contact between the vertical blades and the tissue sample creates vibrations, which are sensed by a vibration sensor. The sensor then transmits a signal to a PC for processing and display. The signal is displayed as a frequency spectrum. The frequency analysis in the range of approximately 200 to 1000 Hz represents the surface smoothness or texture of the sample. A high amplitude peak occurring between 200 to 1000 Hz correlates to a rougher surface and is reported as the TS750 value, having units of dB V2 rms. A further peak in the frequency range between 6 and 7 kHZ represents the softness of the sample. The peak in the frequency range between 6 and 7 kHZ is herein referred to as the TS7 value and is expressed as dB V2 rms. A high amplitude peak correlates to less soft surface, while a low amplitude peak correlates a softer surface.

Tissue product samples were prepared by cutting a circular sample having a diameter of 112.8 mm. All samples were allowed to equilibrate at TAPPI conditions for at least 24 hours prior to completing the TSA testing. After conditioning each sample was tested as-is, i.e., multiply products were tested without separating the sample into individual plies.

Samples are mounted into the instrument and the test is carried out according to the manufacturer's instructions. When complete, the TSA software displays values for TS7 and TS750. These values are recorded to the nearest 0.01 dB V2 rms. Once testing is complete, the sample is removed from the instrument and discarded. The test is performed on the top surface (outer facing surface of a rolled product) of five of the replicate samples, using a new sample for each test. The five test results are averaged and the average value is reported.

### Examples

Basesheets were made using a through-air dried papermaking process commonly referred to as “uncreped through-air dried” (“UCTAD”) and generally described in U.S. Pat. No. 5,607,551, the contents of which are incorporated herein in a manner consistent with the present invention. Base sheets with a target bone dry basis weight of about 27 grams per square meter (gsm) were produced. The base sheets were then converted into a multiply product and spirally wound into rolled tissue products, as described in more detail below.

The inventive samples comprised a blend of high yield hesperaloe (HYH) pulp fibers and eucalyptus kraft pulp fibers (EHWK). HYH pulp was prepared without the use of chemicals. More particularly, HYH was prepared by processing the hesperaloe biomass using a two-stage screw press, which cut the biomass to a nominal size of about and 20 mm and removed about 55 wt % of the water-soluble extractives. The extracted and cut biomass was washed by mixing with water at a consistency ranging from 1% to 5%, dewatered to a consistency of 40% to 50%, and then diluted with hot water to a consistency of about 4%. The diluted bagasse was fed to an Andritz 36-1CP single disc refiner operating at atmospheric pressure, a temperature of about 130 F and rotational disc speed of 900 rpm.

After the first refining the stage the refined bagasse was discharged into a retention tank and further diluted with hot water to a consistency of 3%. The diluted, refined bagasse was then fed to an Andritz TwinFlow IIIB refiner having a rotational disc refiner plate operating at 1,200 rpm. After secondary refining the pulp was diluted with water to a consistency of 2% and passed through a pressure screen. The pressure screen has a Dolphin rotor design equipped with a PG25-03 micro-slotted screen basket having 0.1 mm slots. The screen fractioned the pulp into accepts and rejects. The primary pulp was bleached using 12% hydrogen peroxide solution, 4% NaOH, 3% NaSi, 0.5% DTPA in a single stage. The fiber properties bleached HYH pulp are summarized in Table 1, below.

TABLE 1

| | Mechanical HYH Pulp |
|---|---|
| Tensile Index (0 Rev.) | 49 |
| Freeness (mL) | 444 |
| Fiber Length (mm) | 1.82 |
| Coarseness (mg/100 m) | 5.3 |
| Very Long Fiber (%) | 0.06 |

Tissue products were manufactured by forming a base web from EHWK and NSWK or EHWK and mechanical HYH pulp. The composition of the webs is further described in Table 2, below. In all instances, the fiber furnish consisted of 40 wt % EHWK. In those instances where the sample contained NSWK, the NSWK was subjected to batch refining at refining at 4.5 hp-days/metric ton for 3 minutes. A debonder (ProSoft™, commercially available from Solenis LLC, Wilmington, DE, U.S.A) was added in certain instances as indicated in Table 2, below. In certain instances, CMC was also added to control strength, as indicated in Table 2, below. In all instances, a permanent wet strength agent (Kymene™, commercially available from Solenis LLC, Wilmington, DE, U.S.A) was added as indicated in Table 2, below.

TABLE 2

| | | | | | Permanent | |
|---|---|---|---|---|---|---|
| | Layer | | | | Wet | |
| | Struc- | HYH/NSWK | | Debonder | Strength | CMC |
| Sample | ture | (wt %) | | (kg/MT) | (kg/MT) | (kg/MT) |
| 1 | Layered | NSWK | (60%) | 0 | 9 | 3 |
| 2 | Layered | NSWK | (60%) | 0 | 9 | 0 |
| 3 | Layered | NSWK | (60%) | 0 | 12 | 6 |
| 4 | Blended | HYH | (60%) | 0 | 9 | 0 |
| 5 | Blended | HYH | (60%) | 10 | 15 | 0 |
| 6 | Blended | HYH | (60%) | 18 | 12 | 0 |

The tissue web was formed on a Voith Fabrics TissueForm V forming fabric, vacuum dewatered to approximately 25 percent consistency and then subjected to rush transfer at a rate of 24 percent when transferred to the transfer fabric. The transfer fabric was a Voith T807-5 (commercially available from Voith Paper, Inc., Appleton WI). The web was then transferred to a woven through-air drying fabric having a plurality of substantially machine direction (MD) oriented ridges spaced apart from one another approximately 3.5 mm. The MD ridges were substantially continuous in the MD of the fabric and woven in a parallel, spaced apart arrangement to define valleys there between, where the valleys have a depth of about 1.5 mm. Transfer to the through-drying fabric was done using vacuum levels of greater than 6 inches of mercury at the transfer. The web was then dried to approximately 98 percent solids before winding.

The base sheet, prepared as described above, was converted into a two-ply rolled towel product. Specifically, base sheet was calendered using a patterned steel roll and a 40 P&J polyurethane roll, substantially as described in U.S. Pat. No. 10,040,265, the contents of which are incorporated herein in a manner consistent with the present invention, at a load of 30 pli. The calendered base sheet was then converted to a two-ply product by embossing and laminating substantially as illustrated in FIG. 3. The finished tissue product was subjected to physical testing, the results of which are shown in Tables 3, below

TABLE 3

| | Basis | | | GM | | |
|---|---|---|---|---|---|---|
| | Weight | GMT | GM TEA | Slope | Stiffness | |
| Sample | (gsm) | (g/3″) | (g · cm/cm²) | (kg) | Index | TS7 |
| 1 | 53.7 | 4700 | 6.71 | 20.42 | 4.34 | 22.2 |
| 2 | 54.8 | 3826 | 8.64 | 21.31 | 5.57 | 19.0 |
| 3 | 50.4 | 3692 | 10.12 | 15.05 | 4.08 | 21.5 |
| 4 | 53.9 | 4770 | 6.23 | 24.55 | 5.15 | 18.9 |
| 5 | 53.2 | 3853 | 7.48 | 18.24 | 4.73 | 17.9 |
| 6 | 53.1 | 3341 | 9.54 | 22.36 | 6.69 | 16.1 |

The foregoing is one example of an inventive tissue product prepared according to the present disclosure. In a 1^{st} embodiment the invention provides a tissue product comprising two or more tissue plies, where the tissue pies may be through air dried tissue plies and more preferably uncreped through air dried tissue plies, wherein at least one of the tissue pies comprise hesperaloe pulp fibers and wood pulp fibers and wherein the hesperaloe fibers comprise at least 5 wt % of the tissue product.

Second embodiment: The product of the first embodiment having a geometric mean tensile strength (GMT) of about 2,000 g/3″ or greater and TS7 from about 15.0 to about 20.0.

Third embodiment: The product of any one of embodiments 1 or 2 wherein the tissue product comprises from about 5 to about 50 percent, by weight of the product, hesperaloe pulp fibers.

Fourth embodiment: The product of any one of embodiments 1-3 wherein the tissue product has a geometric mean tensile energy absorption (GM TEA) greater than about 30.0 g·cm/cm².

Fifth embodiment: The tissue product of any one of embodiments 1-4 having a TEA Index of about 7.5 or greater.

Sixth embodiment: The tissue product of any one of embodiments 1-5 wherein the tissue product has a Stiffness Index from 4.0 to 8.0.

Seventh embodiment: The tissue product of any one of embodiments 1-6 having a geometric mean slope (GM Slope) of less than about 20.0 kg.

Eighth embodiment: The tissue product of any one of embodiments 1-7 having a basis weight from about 50 to about 60 gsm.

Ninth embodiment: The tissue product of any one of embodiments 1-8 having a sheet bulk greater than about 10 cc/g.

Tenth embodiment: The tissue product of any one of embodiments 1-9 having a dry burst strength of about 800 gf or greater.

Eleventh embodiment: The tissue product of any one of embodiments 1-10 having a geometric mean tear (GM Tear) of about 35.0 gf or greater.

Twelfth embodiment: The tissue product of any one of embodiments 1-11 wherein the first tissue ply or the second tissue ply comprises a homogenous blend of hesperaloe pulp fibers and wood pulp fibers.

Thirteenth embodiment: The tissue product of any one of embodiments 1-12 wherein the first tissue ply and the second tissue ply comprise a homogenous blend of hesperaloe pulp fibers and hardwood kraft pulp fibers, wherein the tissue product comprises from about 10% to about 50% hesperaloe pulp fibers and is substantially free from softwood kraft pulp fibers.

Fourteenth embodiment: The tissue product of any one of embodiments 1-13 wherein the tissue product has a having a TS7 value equal to or less than 0.0018(GMT)+10.304 where GMT is the geometric mean tensile strength of the tissue product having units of grams per three inches. In certain embodiments the GMT may range from about 3,000 g/3″ to about 5,500 g/3″.

Fifteenth embodiment: The tissue product of any one of embodiments 1-1 4 wherein hesperaloe pulp fibers are high yield hesperaloe pulp fibers, which in certain embodiments may be produced by mechanically refining hesperaloe biomass without the addition of chemicals.

Sixteenth embodiment: The tissue product of any one of embodiments 1-15 wherein the hesperaloe pulp fibers have a Fiber Length of at least about 1.50 mm and Coarseness from about 3.5 to about 6.0 mg/100 m.

Seventeenth embodiment: The tissue product of any one of embodiments 1-16 wherein each of the first and second tissue plies comprise a first and second outer surface and at least the first outer surface comprises hesperaloe pulp fibers.

Eighteenth embodiment: The tissue product of any one of embodiments 1-17 wherein product is substantially free from softwood kraft pulp fibers and more preferably substantially free from Northem softwood kraft pulp fibers.

Nineteenth embodiment: The tissue product of any one of embodiments 1-18 wherein the first and second tissue plies consist essentially of hardwood kraft pulp fibers and high yield hesperaloe pulp fibers and the amount of high yield hersperaloe pulp fibers ranges from about 20 wt % to about 40 wt % of the tissue product.

Twentieth embodiment: The tissue product of any one of embodiments 1-19 wherein the tissue product is embossed.

Twenty-first embodiment: The tissue product of any one of embodiments 1-20 the first or the second ply comprise more than one layer and hesperaloe pulp fibers and wood pulp fibers are disposed in each of the one or more layers.

Twenty-second embodiment: The tissue product of any one of embodiments 1-21 the first or the second ply comprise a single layer and the single layer comprises a blend of wood pulp fibers and hesperaloe pulp fibers.

What is claimed is:

1. A multiply tissue product comprising a first tissue ply and a second tissue ply, wherein the tissue product comprises at least about 5 percent hesperaloe pulp fiber, by weight of the tissue product, the tissue product having a basis weight of about 40 grams per square meter (gsm) or greater, a geometric mean tensile strength (GMT) of about 2,000 g/3″ or greater and TS7 from about 15.0 to about 20.0.

2. The tissue product of claim 1 wherein the tissue product comprises from about 5 to about 50 percent, by weight of the product, hesperaloe pulp fibers.

3. The tissue product of claim 1 wherein the tissue product has a geometric mean tensile energy absorption (GM TEA) greater than about 30.0 g·cm/cm².

4. The tissue product of claim 3 having a TEA Index of about 7.5 or greater.

5. The tissue product of claim 1 wherein the tissue product has a Stiffness Index from 4.0 to 8.0.

6. The tissue product of claim 1 having a geometric mean slope (GM Slope) of less than about 20.0 kg.

7. The tissue product of claim 1 having a basis weight from about 50 to about 60 gsm.

8. The tissue product of claim 7 having a sheet bulk greater than about 10 cc/g.

9. The tissue product of claim 1 having a dry burst strength of about 800 gf or greater.

10. The tissue product of claim 1 having a geometric mean tear (GM Tear) of about 35.0 gf or greater.

11. The tissue product of claim 1 wherein the first tissue ply or the second tissue ply comprises a homogenous blend of hesperaloe pulp fibers and wood pulp fibers.

12. The tissue product of claim 1 wherein the first tissue ply and the second tissue ply comprise a homogenous blend of hesperaloe pulp fibers and hardwood kraft pulp fibers, wherein the tissue product comprises from about 10% to about 50% hesperaloe pulp fibers and is substantially free from softwood kraft pulp fibers.

13. The tissue product of claim 1 wherein the tissue product has a having a TS7 value equal to or less than 0.0018(GMT)+10.304 where GMT is the geometric mean tensile strength of the tissue product having units of grams per three inches.

14. The tissue product of claim 13 the GMT ranges from about 3,000 g/3″ to about 5,500 g/3″.

15. A method of manufacturing a multiply tissue product comprising the steps of:
a. dispersing hesperaloe pulp fiber in water to form a first fiber slurry;
b. dispersing wood pulp fibers in water to form a second fiber slurry;
c. blending the first and the second fiber slurries together and depositing them on a moving belt to form a tissue web;
d. non-compressively drying the tissue web to yield a dried tissue web having a consistency from about 80 to about 99 percent solids and comprising at least 5%, by weight of the tissue web, high yield hesperlaoe pulp fibers; and
e. plying two dried tissue webs together to form a multiply tissue product.

16. The method of claim 15 wherein the hesperaloe pulp fibers have been produced by mechanically refining hesperaloe biomass without the addition of chemicals.

17. The method of claim 15 wherein the hesperaloe pulp fibers have a Fiber Length of at least about 1.50 mm and Coarseness from about 3.5 to about 6.0 mg/100 m.

18. The method of claim 15 further comprising the step of embossing the dried tissue web.

19. The method of claim 15 further comprising the step of calendering the dried tissue web.

20. The method of claim 15 wherein the multiply tissue product has a TS7 value equal to or less than 0.0018(GMT)+10.304 where GMT is the geometric mean tensile strength of the tissue product having units of grams per three inches.
